(19) United States
(12) Patent Application Publication
(10) Pub. No.: US 2010/0231970 A1
(43) Pub. Date: Sep. 16, 2010

(54) PRINTING SYSTEM AND PRINTER TERMINAL

(75) Inventors: Takafumi Higuchi, Matsumoto-shi (JP); Kenji Sakuda, Suwa-shi (JP); Yasuhiro Oshima, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/722,461

(22) Filed: Mar. 11, 2010

(30) Foreign Application Priority Data
Mar. 13, 2009 (JP) 2009-061877

(51) Int. Cl. G06F 3/12

(52) U.S. Cl. 358/1.15; 358/1.17

(57) ABSTRACT

A printing system including a transmitting terminal that transmits printable print content and a printer terminal that receives and prints the print content, the terminals being connected via an IP network.

### BACKGROUND

1. Technical Field

The entire disclosure of Japanese Patent Application No. 2009-061877, filed Mar. 13, 2009 is expressly incorporated by reference herein.

The present invention relates to a printing system and a printer terminal, and particularly relates to a printing system in which a transmitting terminal that translates printable print content and a printer terminal that receives and prints the print content are connected via an IP network, and a printer terminal that is connected to a transmitting terminal that transmits printable print content and that receives and prints the print content transmitted by the transmitting terminal.

2. Related Art

A personal computer or the like connected to a fax machine or printer that receives print data via a communication network such as a telephone line or the Internet and prints that print data is known as a past example of this type of printer terminal. With a fax machine, which receives print data via a telephone line, a call is responded to using a signal, which is the fax, and the print data is printed each time a new instance of print data is received, or the print data is stored in a memory and printed thereafter. Meanwhile, with a personal computer that receives print data via the Internet, the print data is stored in an external storage device such as a hard disk, after which an application for printing is launched and the print data stored in external storage device is read out and printed. Techniques such as those disclosed in the following Patent Documents JP-A-2005-109701, JP-A-2003-178028, JP-A-2005-516320 are known as techniques regarding the transmission of information using a network.

In recent years, next-generation networks (NGNs) are being proposed as next-generation information communication networks that exhibit the flexibility and economic efficiency of IP (Internet Protocol) networks while maintaining the reliability and stability of the telephone networks of the past. With these next-generation networks, the Session Initiation Protocol (SIP) is used as the protocol for creating, modifying, and terminating sessions necessary for exchanging audio, video, text messages, and so on with two or more partners at the application layer. When initiating a session between devices using SIP, an offerer terminal, who is requesting the session initiation, transmits an INVITE message containing a URI (Uniform Resource Identifier) that specifies the location on the network of an answerer terminal, who is being requested to initiate the session. The session is initiated by the answerer terminal transmitting a “200 OK” status code acknowledging the session initiation to the offerer in response to the INVITE message. The data transfer between the terminals following this session initiation is usually performed through push-type communications from the offerer terminal, but depending on the capabilities of the answerer terminal, there are cases where the data transfer cannot be properly carried out. In particular, when the answerer terminal is a printer device and printing is to be performed as data is received, it is necessary to transmit the data in accordance with the print speed.

### SUMMARY

An advantage of some aspects of the invention provides a printer terminal and a control method thereof for properly receiving print content via an IP network and printing that content.

The printing system and printer terminal of the invention employ the following units to achieve the advantage described above.

A printing system according to an aspect of the invention includes a transmitting terminal that transmits printable print content and a printer terminal that receives and prints the print content, the terminals being connected via an IP network. The transmitting terminal has: a transmission-side connection initiation execution unit that initiates a connection with the printer terminal via the IP network based on the transmission of a connection request message that contains print identification information for transmitting/receiving the print content; and a print content transmitting unit that transmits the print content to the printer terminal in response to a request from the printer terminal, the print content transmitting unit functioning as the server in the server/client model when the connection with the printer terminal is initiated based on the transmission of the connection request message that contains the print identification information. The printer terminal has: a storage unit capable of temporarily storing data; a print execution unit that prints print data; a reception-side connection initiation execution unit that initiates a connection along with the transmitting terminal via the IP network based on the reception of the connection request message that contains the print identification information; and a print content reception/printing control unit that receives the print content from the transmitting terminal having issued, to the transmitting terminal, a request to transmit the print content, and controls the print execution unit so that the received print content is printed, the print content reception/printing control unit functioning as the client in the client/server model when the connection with the transmitting terminal is initiated based on the reception of the connection request message containing the print identification information.

With the printing system according to this aspect of the invention, when the transmitting terminal transmits a connection request message containing print identification information for transmitting/receiving print content, and a connection is established between the transmitting terminal and the printer terminal via the IP network based on the printer terminal receiving the connection request message, the transmitting terminal functions as the server in the server/client model and the printer terminal functions as the client in the server/client model; the transmitting terminal then transmits print content to the printer terminal in response to the request for transmission of the print content from the printer terminal. The printer terminal then receives the print content transmitted from the transmitting terminal and prints that print content. In this manner, when transmitting/receiving print content, causing the transmitting terminal to function as the server in the server/client model and causing the printer terminal to function as the client in the server/client model, or in other words, transmitting/receiving the print content under the direction of the printer terminal, makes it possible to transmit/receive and print the print content in accordance with the capabilities of the printer terminal. As a result, the print content can be properly received and printed via the IP network. Here, the IP network employed can be a next-generation network (NGN), and the establishment of a connection can be carried out through the Session Initiation Protocol (SIP).

In the printing system according to this aspect of the invention, the print content reception/printing control unit of the printer terminal may receive data multiple times by transmitting, to the transmitting terminal, multiple data transmission requests for a data amount that is within the range of a print memory capacity allocated to print data from the storage capacity of the storage unit, and control the print execution unit so that the received data is printed by the print execution unit with each data reception; and the print content transmitting unit of the transmitting terminal may transmit the print content by transmitting data multiple times in response to the data transmission requests from the printer terminal. Doing so makes it possible to receive, over multiple receptions, data of data amount that is within the range of the print memory capacity allocated to print data from the storage capacity of the storage unit in the printer terminal, and to print the data with each data reception. As a result, the print content can be properly received and printed via the IP network even if the print memory capacity in the printer terminal is small. In this case, the print content reception/printing control unit of the printer terminal may perform control so that data transmission requests are made for each of predetermined printing ranges and the data received from the predetermined printing ranges is printed on a range-by-range basis; the transmitting terminal may further have a scan execution unit that reads an image; and the print content transmitting unit of the transmitting terminal may control the scan execution unit to read a portion of the image corresponding to the predetermined printing rage in response to a data transmission request from the printer terminal, and transmits the read data to the printer terminal. Doing so makes it possible to print data obtained by the transmitting terminal scanning and transmitting an image in predetermined printing range units in those predetermined printing range units. Furthermore, in this case, the storage unit of the printer terminal may be provided with two print memory regions, each having a storage capacity equivalent to one page; the predetermined printing range may be one page; and the print content reception/printing control unit of the printer terminal may make a data transmission request so that data is written into one of the print memory regions when the data stored in the other print memory region is being printed. Doing so makes it possible to use the two print memory regions in order to print and transmit/receive data in an alternating manner.

A printer terminal according to an aspect of the invention is connected via an IP network to a transmitting terminal that transmits printable print content and that prints the print content transmitted from the transmitting terminal. The printer terminal includes: a storage unit capable of temporarily storing data; a print execution unit that prints print data; a reception-side connection initiation execution unit that initiates a connection along with the transmitting terminal via the IP network based on the reception of a connection request message that contains print identification information for transmitting/receiving the print content transmitted from the transmitting terminal; and a print content reception/printing control unit that receives the print content from the transmitting terminal having issued, to the transmitting terminal, a request to transmit the print content, and controls the print execution unit so that the received print content is printed, the print content reception/printing control unit functioning as the client in the client/server model when the connection with the transmitting terminal is initiated based on the reception of the connection request message containing the print identification information.

With the printer terminal according to this aspect of the invention, when a connection between the transmitting terminal and the printer terminal is established via the IP network based on the reception of a connection request message containing print identification information for transmitting/receiving print content transmitted from the transmitting terminal, the printer terminal functions as the client in the server/client model, and receives and prints print content transmitted from the transmitting terminal in response to a request to transmit print content issued by the printer terminal. In this manner, when transmitting/receiving print content, causing the printer terminal to function as the client in the server/client model and causing the transmitting terminal to function as the server in the server/client model, or in other words, transmitting/receiving the print content under the direction of the printer terminal, makes it possible to transmit/receive and print the print content in accordance with the capabilities of the printer terminal. As a result, the print content can be properly received and printed via the IP network. Here, the IP network employed can be a next-generation network (NGN), and the establishment of a connection can be carried out through the Session Initiation Protocol (SIP).

In the printer terminal according to this aspect of the invention, the print content reception/printing control unit may receive data multiple times by transmitting, to the transmitting terminal, multiple data transmission requests for a data amount that is within the range of a print memory capacity allocated to print data from the storage capacity of the storage unit, and may control the print execution unit so that the received data is printed by the print execution unit with each data reception. Doing so makes it possible to receive, over multiple receptions, data of data amount that is within the range of the print memory capacity allocated to print data from the storage capacity of the storage unit in the printer terminal, and to print the data with each data reception. As a result, the print content can be properly received and printed via the IP network even if the print memory capacity in the printer terminal is small. In this case, the print content reception/printing control unit may perform control so that data transmission requests are made for each of predetermined printing ranges and the data received from the predetermined printing ranges is printed on a range-by-range basis. Doing so makes it possible to cause the transmitting terminal to transmit data corresponding to a predetermined printing range and print the data on a range-by-range basis. Furthermore, in this case, the storage unit may be provided with two print memory regions, each having a storage capacity equivalent to one page; the predetermined printing range may be one page; and the print content reception/printing control unit may make a data transmission request so that data is written into one of the print memory regions when the data stored in the other print memory region is being printed. Doing so makes it possible to use the two print memory regions in order to print and transmit/receive data in an alternating manner.

### BRIEF DESCRIPTION OF THE DRAWINGS

The invention will be described with reference to the accompanying drawings, wherein like numbers reference like elements.

FIG. 1 is a descriptive diagram illustrating an IP network, an outgoing correspondence terminal, and an incoming correspondence terminal.

FIG. 2 is a descriptive diagram illustrating a communication sequence between the outgoing correspondence terminal and the incoming correspondence terminal.

FIG. 3 is a descriptive diagram illustrating an example of the SDP content of an INVITE message.

FIG. 4 is a descriptive diagram illustrating an example of the SDP content of a 200 OK message.

FIG. 5 is a flowchart illustrating processing performed on the incoming correspondence side when transmitting/receiving print content data.

FIG. 6 is a flowchart illustrating processing performed on the outgoing correspondence side when transmitting/receiving print content data.

FIG. 7 is a descriptive diagram illustrating a sequence performed when transmitting/receiving print content data.

FIG. 8 is a descriptive diagram illustrating an example of the content of a sequence [1] capability request.

FIG. 9 is a descriptive diagram illustrating an example of the content of a sequence [2] capability response.

FIG. 10 is a descriptive diagram illustrating an example of the content of a sequence [3] page information request.

FIG. 11 is a descriptive diagram illustrating an example of the content of a sequence [4] page information response.

FIG. 12 is a descriptive diagram illustrating an example of the content of a sequence [5] data request.

FIG. 13 is a descriptive diagram illustrating an example of the content of a sequence [6] data response.

FIG. 14 is a descriptive diagram illustrating an example of the content of a sequence [7] page information response.

FIG. 15 is a flowchart illustrating processing performed on the incoming correspondence side according to a variation.

### DESCRIPTION OF EXEMPLARY EMBODIMENTS

Next, an embodiment of the invention will be described using a working example.

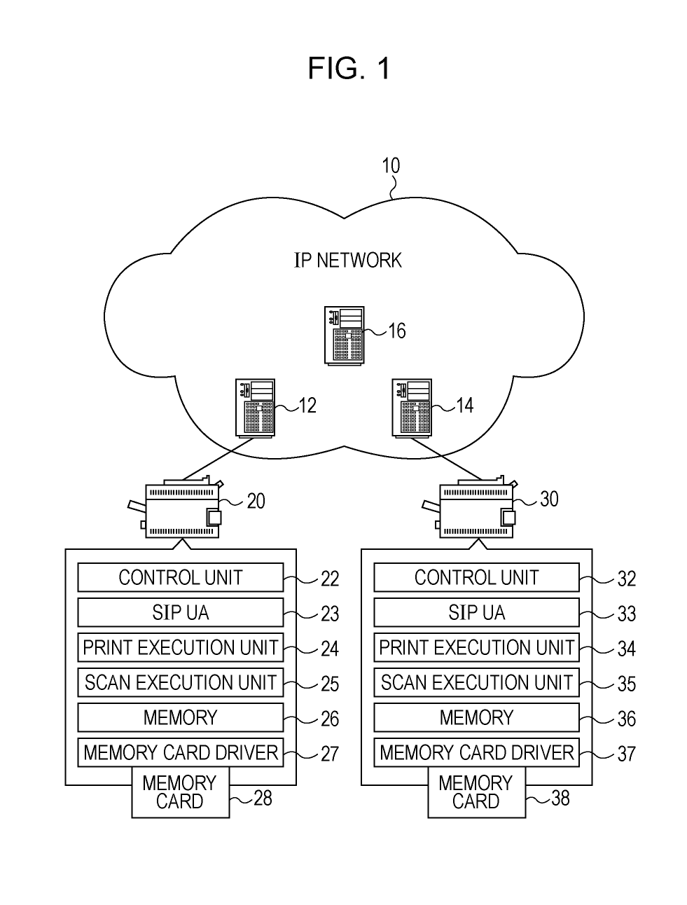

FIG. 1 is a block diagram illustrating an example of the configuration of a printing system configured of image processing devices 20 and 30 that function as printer terminals and an IP (Internet Protocol) network 10 that connects the image processing devices 20 and 30, according to a working example of the invention. As illustrated in FIG. 1, the image processing devices 20 and 30 are connected to an SIP (Session Initiation Protocol) proxy servers 12 and 14, respectively, of which the IP network 10 is constructed.

The IP network 10 is configured of, for example, a next-generation network (NGN), and is configured of the SIP proxy servers 12 and 14, a location server 16, and so on. The SIP proxy servers 12 and 14 not only relay IP messages, but also function as registrars for registering location information (for example, a URI (Uniform Resource Identifier) or the like) of the user agents of the image processing devices 20 and 30 in the location server 16.

The image processing devices 20 and 30 are configured as multifunction peripherals that function both as scanners and as printers, and respectively include: control units 22 and 32 that control the devices as a whole; Session Initiation Protocol (SIP) user agents (SIP UAs) 23 and 33; print execution units 24 and 34 that print text, image data, and so on; scan execution units 25 and 35 that scan text, images, or the like on a medium such as paper and obtain image data thereby; memories 26 and 36 that temporarily store data for printing, image data obtained through scanning, and so on; memory card drivers 27 and 37 that write data into the memories of memory cards 28 and 38 or read out data that is stored in the memories of the memory cards 28 and 38 when the memory cards 28 and 38 have been connected; and so on.

The following descriptions assume a situation in which image data scanned by the image processing device 20 is transmitted as print content data from the image processing device 20 to the image processing device 30 via the IP network 10 and the image processing device 30 that has received the print content data then prints that print content data; therefore, the image processing device 20 will be called an “outgoing correspondence terminal 20”, and image processing device 30 will be called an “incoming correspondence terminal 30”.

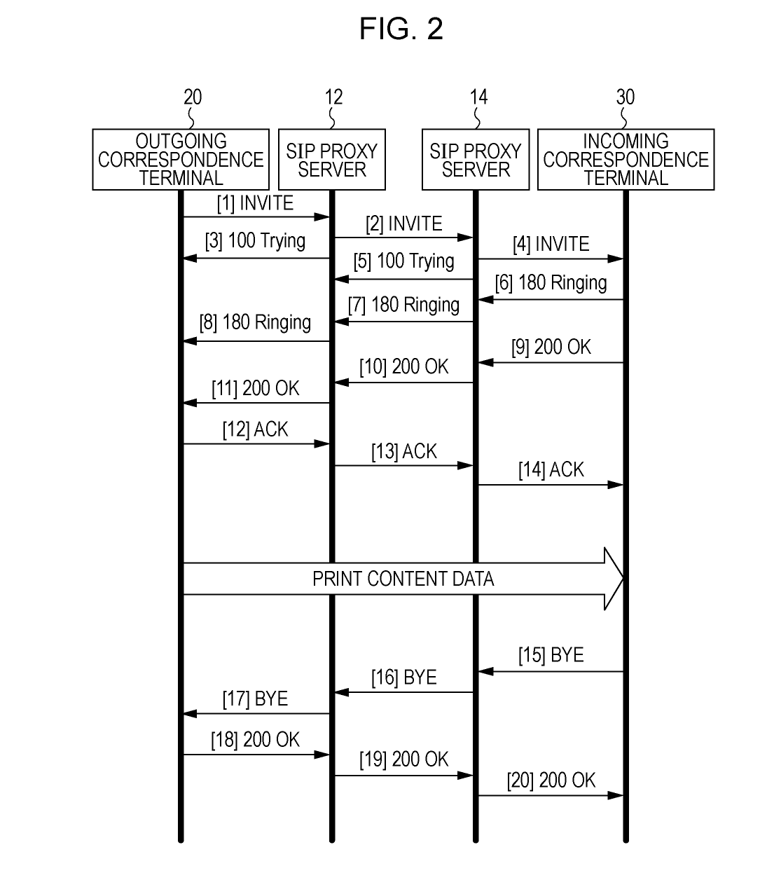

FIG. 2 is a descriptive diagram illustrating a communication sequence between the outgoing correspondence terminal 20 and the incoming correspondence terminal 30, based on the Session Initiation Protocol, when image data scanned by the outgoing correspondence terminal 20 is transmitted as print content data from the outgoing correspondence terminal 20 to the incoming correspondence terminal 30 and the incoming correspondence terminal 30 that received the image data then prints the image data. The initiation of a session through SIP is carried out by the outgoing correspondence terminal 20 first transmitting an INVITE message to the incoming correspondence terminal 30. The INVITE message from the outgoing correspondence terminal 20 is first transmitted to the SIP proxy server 12. As a response, the SIP proxy server 12 transmits a status code of “100 Trying” indicating that processing is underway to the outgoing correspondence terminal 20, and also transmits the INVITE message to the SIP proxy server 14 based on the URI (Uniform Resource Identifier) of the incoming correspondence terminal 30 as written in the INVITE message. Then, as a response, the SIP proxy server 14 transmits a status code of “100 Trying” indicating that processing is underway to the SIP proxy server 12, and also transmits the INVITE message to the incoming correspondence terminal 30 based on the URI (Uniform Resource Identifier) of the incoming correspondence terminal 30 as written in the INVITE message. As a response, the incoming correspondence terminal 30 transmits a status code of “180 Ringing” indicating that it is calling in response to the reception of the INVITE message. This “180 Ringing” is transmitted to the outgoing correspondence terminal 20 via the SIP proxy server 14 and the SIP proxy server 12. After this, the incoming correspondence terminal 30 transmits a status code of “200 OK” indicating that the call for initiating the session made in response to the received INVITE message has succeeded. This “200 OK” is transmitted to the outgoing correspondence terminal 20 via the SIP proxy server 14 and the SIP proxy server 12, and upon receiving this “200 OK”, the outgoing correspondence terminal 20 transmits a status code of “ACK”, confirming the reception of a final response to the INVITE message, to the incoming correspondence terminal 30 via the SIP proxy server 12 and the SIP proxy server 14. Having performed the above, the connection between the outgoing correspondence terminal 20 and the incoming correspondence terminal 30 is established, thus enabling the outgoing correspondence terminal 20 to transmit print content data to the incoming correspondence terminal 30. When the transmission of print content data by the outgoing correspondence terminal 20 and the printing of the print content data by the incoming correspondence terminal 30 have ended, the incoming correspondence terminal 30 transmits a status code of “BYE” for terminating the session to the outgoing correspondence terminal 20 via the SIP proxy server 14 and the SIP proxy server 12. The session is terminated when the outgoing correspondence terminal 20 transmits a “200 OK” to the incoming correspondence terminal 30 via the SIP proxy server 12 and the SIP proxy server 14 in response thereto. Note that initiating and terminating sessions via the SIP proxy server 12 and the SIP proxy server 14 makes it possible for the administrators of the SIP proxy server 12 and the SIP proxy server 14 to obtain the dates/times at which sessions have been established and terminated between the outgoing correspondence terminal 12 and the incoming correspondence terminal 30 and calculate a value (a bill) for the service involved in the establishment of sessions between the outgoing correspondence terminal 20 and the incoming correspondence terminal 30.

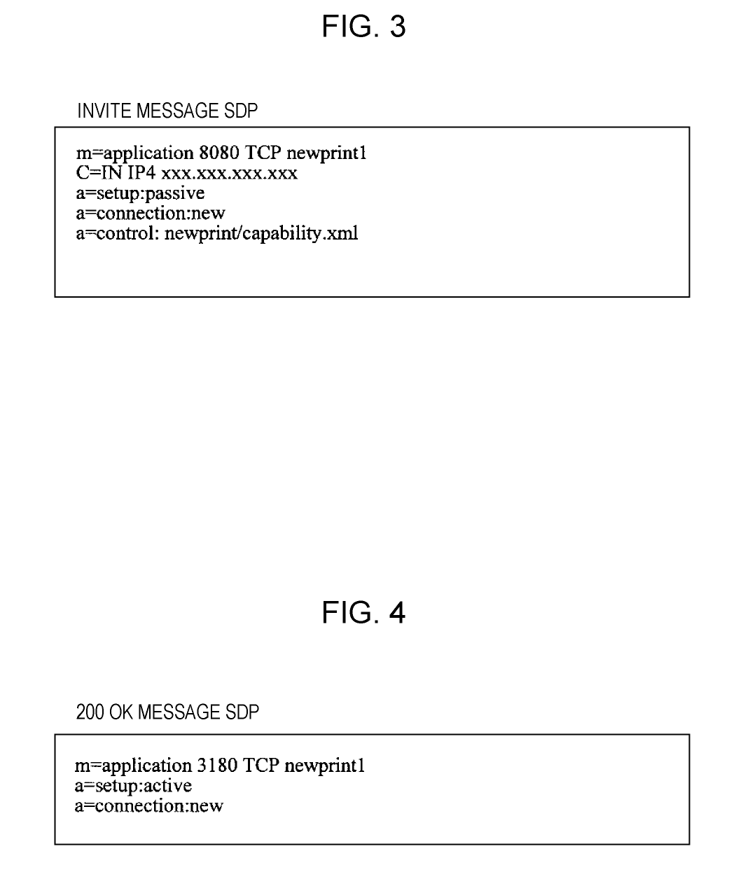

FIG. 3 is a descriptive diagram illustrating an example of the SDP (Session Description Protocol) content in an INVITE message transmitted from the outgoing correspondence terminal 20 in the working example, and FIG. 4 is a descriptive diagram illustrating an example of the SDP content in a “200 OK” message transmitted from the incoming correspondence terminal 30 in the working example. The SDP in FIG. 3 and FIG. 4 configure media description portions. With SDP, the line “m=” indicates information such as the media type, the transport address, and the like. The line “m=” in FIG. 3 indicates that an application (application) defined by a payload type “newprint1” is to be handled through port number “8080” using “TCP (Transmission Control Protocol)”, and the line “m=” in FIG. 4 indicates that an application (application) defined by the payload type “newprint1” is to be handled through port number “3180” using “TCP”. Here, the description “newprint1” in the line “m=” also functions, in this working example, to identify that the transmission/reception of the print content data is included, and based on this “newprint1” description, the outgoing correspondence terminal 20 functions as the server in the server/client model, and the incoming correspondence terminal 30 functions as the client in the server/client model. This can also be seen by the fact that the outgoing correspondence terminal 20 functions as the “passive side” (the server) based on the description “a=setup:passive” in FIG. 3 the incoming correspondence terminal 30 functions as the “active side” (client) based on the description “a=setup:active” in FIG. 4. With SDP, the line “C=” indicates a media address contained in the session. Because the line “C=” in FIG. 3 contains the description “IN IP4 xxx.xxx.xxx.xxx”, it can be understood that the IP address of the outgoing correspondence terminal 20 is “xxx.xxx.xxx.xxx”. Furthermore, the description “newprint/capability.xml” in the final line “a=” in FIG. 3 is the URL (Uniform Resource Locator) of the destination of the first request from the incoming correspondence terminal 30 following the initiation of the session. Based on this description, the URL for the capability request issued first to the outgoing correspondence terminal 20 by the incoming correspondence terminal 30, which functions as the client in the server/client model, can be obtained.

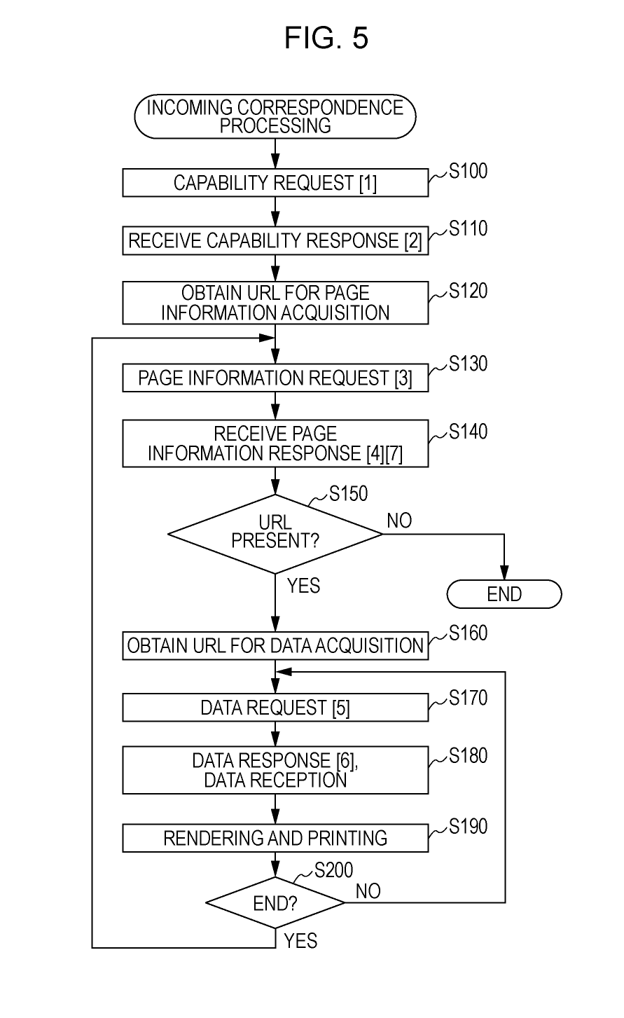

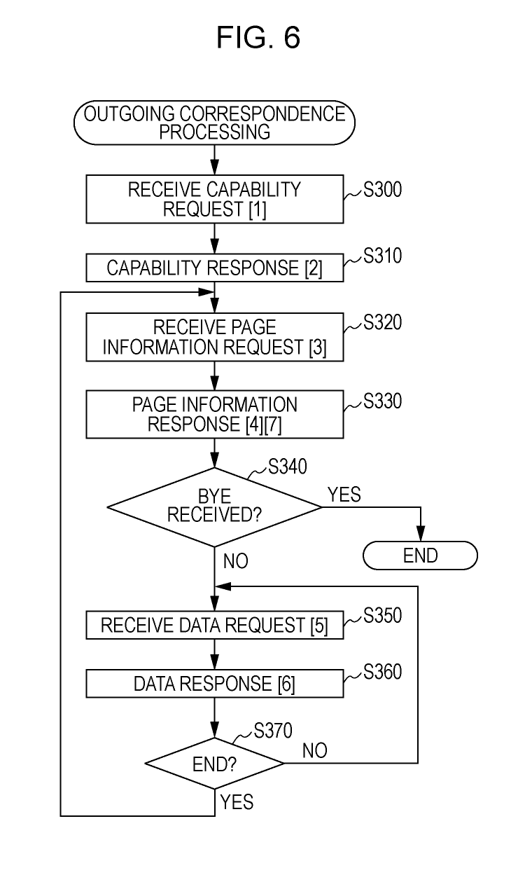

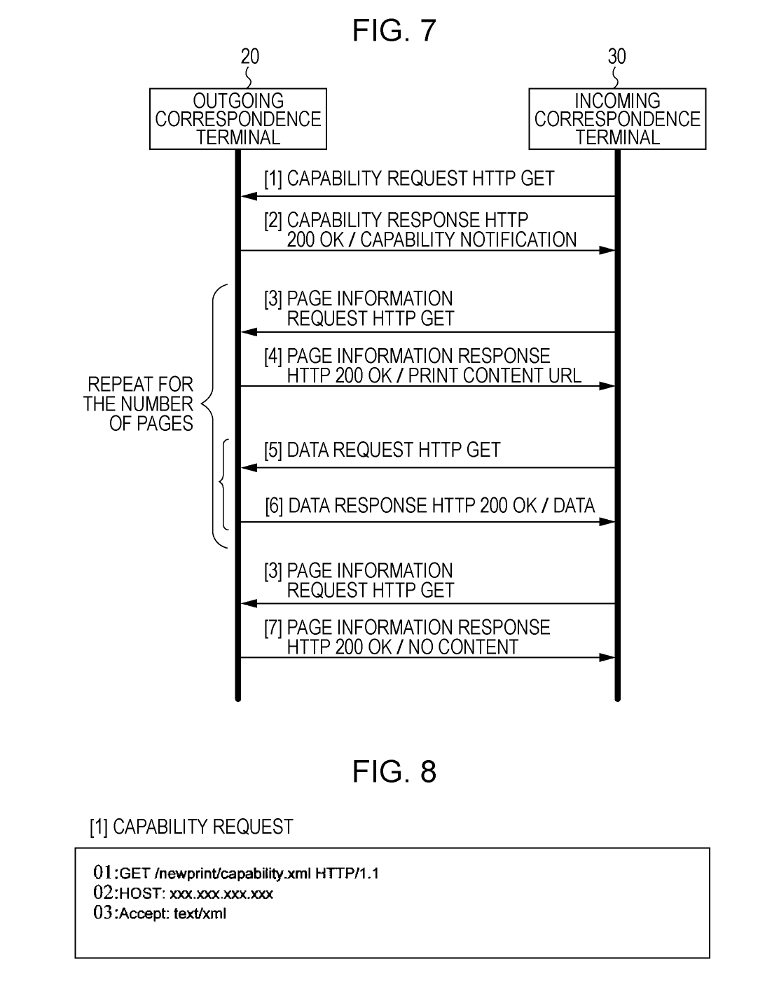

FIG. 5 is a flowchart illustrating an example of processing executed on the incoming correspondence side by the incoming correspondence terminal 30 when print content data is transmitted from the outgoing correspondence terminal 20 to the incoming correspondence terminal 30; FIG. 6 is a flowchart illustrating an example of processing executed on the outgoing correspondence side by the outgoing correspondence terminal 20 when print content data is transmitted from the outgoing correspondence terminal 20 to the incoming correspondence terminal 30; and FIG. 7 is a descriptive diagram illustrating an example of a sequence performed when print content data is transmitted from the outgoing correspondence terminal 20 to the incoming correspondence terminal 30. For descriptive purposes, the transmission/reception and printing of print content data will be described focusing on the sequence in FIG. 7, using the processing on the incoming correspondence side shown in FIG. 5 and the processing on the outgoing correspondence side shown in FIG. 6 as necessary. Note that, as described above, the outgoing correspondence terminal 20 functions as the server in the server/client model and the incoming correspondence terminal 30 functions as the client in the server/client model when a session for transmitting/receiving print content is initiated; therefore, the outgoing correspondence terminal 20 waits for a request from the incoming correspondence terminal 30.

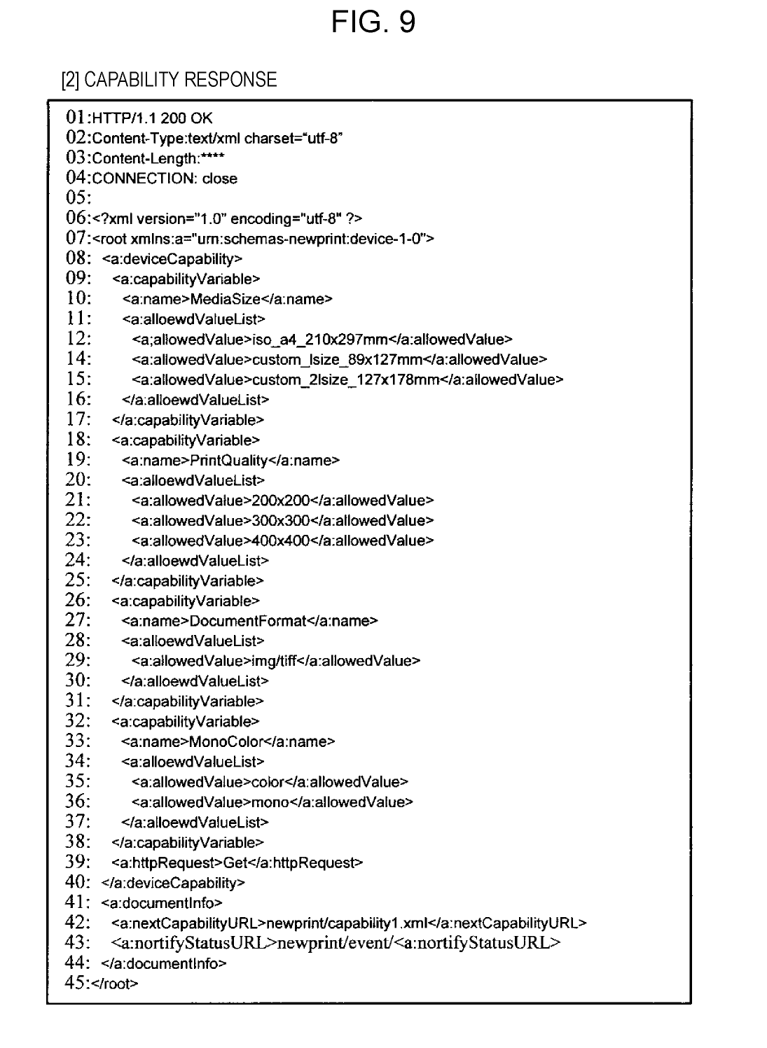

When a session is initiated, the incoming correspondence terminal 30 issues a capability request by transmitting a capability request message to the outgoing correspondence terminal 20 (step S100 in FIG. 5 and step S300 in FIG. 6), and the outgoing correspondence terminal 20 issues a capability response by transmitting a capability response message to the incoming correspondence terminal 30 in response to the capability request (step S310 in FIG. 6 and step S110 in FIG. 5). An example of the capability request message is illustrated in FIG. 8. In the capability request message, the line 01 is a command indicating “request”; the line 02 is the IP address of the outgoing correspondence terminal 20 obtained from the INVITE message; and the line 03 indicates the intent to accept XML text. An example of the capability response message is illustrated in FIG. 9. In the capability response message, the line 01 is “200 OK”, indicating success in response to the request; the line 02 indicates that the type of the content is XML text; and the line 03 expresses the length. In this example, the capabilities of outgoing correspondence terminal 20 can be understood to be the following: paper sizes (“MediaSize” in line 10) of A4 (“iso_a4_{—}210×297 mm” in line 12), L (“custom_lsize_{—}89×127 mm” in line 13), and 2L (“custom_{—}2lsize_{—}127×178 mm” in line 14); qualities (“PrintQuality” in line 19) of 200×200 dpi (“200×200” in line 21), 300×300 dpi (“300×300” in line 22), and 400×400 dpi (“400×400” in line 23); a file format (“DocumentFormat” in line 27) of tiff (Tagged Image File Format) (“img/tiff” in line 29); and a monochromatic/color specification (“MonoColor” in line 33) of color (“color” in line 35) or monochromatic (“mono” in line 36). A URL used when next requesting page information from the incoming correspondence terminal 30 is written in line 42 of the capability response message (“newprint/capability1.xml” in line 42). This URL is a relative address from the IP address “xxx.xxx.xxx.xxx” of the outgoing correspondence terminal 20 described through SDP in the INVITE message (“HOST:xxx.xxx.xxx.xxx” in line 02 of FIG. 8). Furthermore, a URL for receiving status change information is written in line 43 (“newprint/event/” in line 43). This URL for receiving status update information is a URL for the outgoing correspondence terminal 20 to receive information when the incoming correspondence terminal 30 is in an abnormal state, such as when a paper jam has occurred, ink has run out, or the like. Upon receiving the capability response message from the outgoing correspondence terminal 20, the incoming correspondence terminal 30 obtains the capabilities of outgoing correspondence terminal 20 from the capability response message, and also obtains the URL in which the first page information of the print content is described (the “newprint/capability1.xml” in line 42), the URL for receiving status change information (the “newprint/event/” in line 43), and so on (step S120 in FIG. 5).

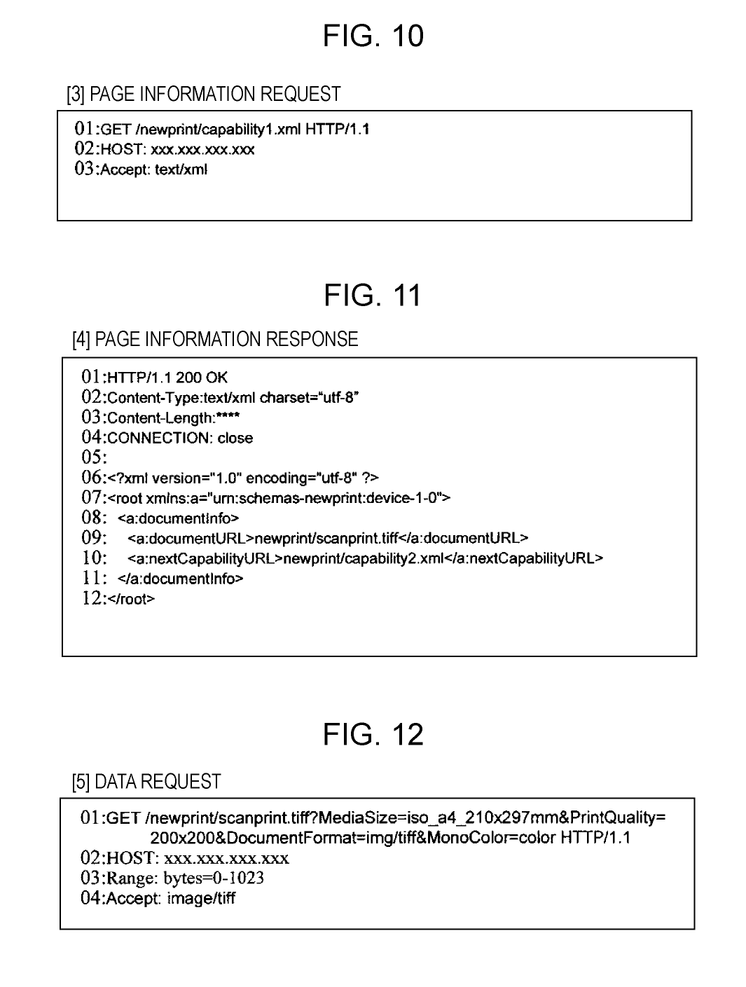

Next, the incoming correspondence terminal 30 issues a page information request by transmitting a page information request message to the outgoing correspondence terminal 20 using the obtained URL (the “newprint/capability1.xml” in line 42 of the capability response message shown in FIG. 9) (step S130 in FIG. 5 and step S320 in FIG. 6), and the outgoing correspondence terminal 20 issues a page information response by transmitting a page information response message to the incoming correspondence terminal in response to the page information request (step S330 in FIG. 6 and step S140 in FIG. 5). An example of the page information request message is illustrated in FIG. 10. It can be seen that the “newprint/capability1.xml” written in line 01 of the page information request message is the same as the “newprint/capability1.xml” in line 42 of the capability response message shown in FIG. 9. An example of the page information response message is illustrated in FIG. 11. It can be seen that a print content data URL of “newprint/scanprint.tiff” is written in line 09 and a URL “newprint/capability2.xml” of the next page of the print content is written in line 10 of the page information response message. Upon receiving the page information response message from the outgoing correspondence terminal 20, if the page information response message contains a print content data URL or a URL of the next page of the print content, the incoming correspondence terminal 30 obtains these URLs (steps S150 and S160 in FIG. 5).

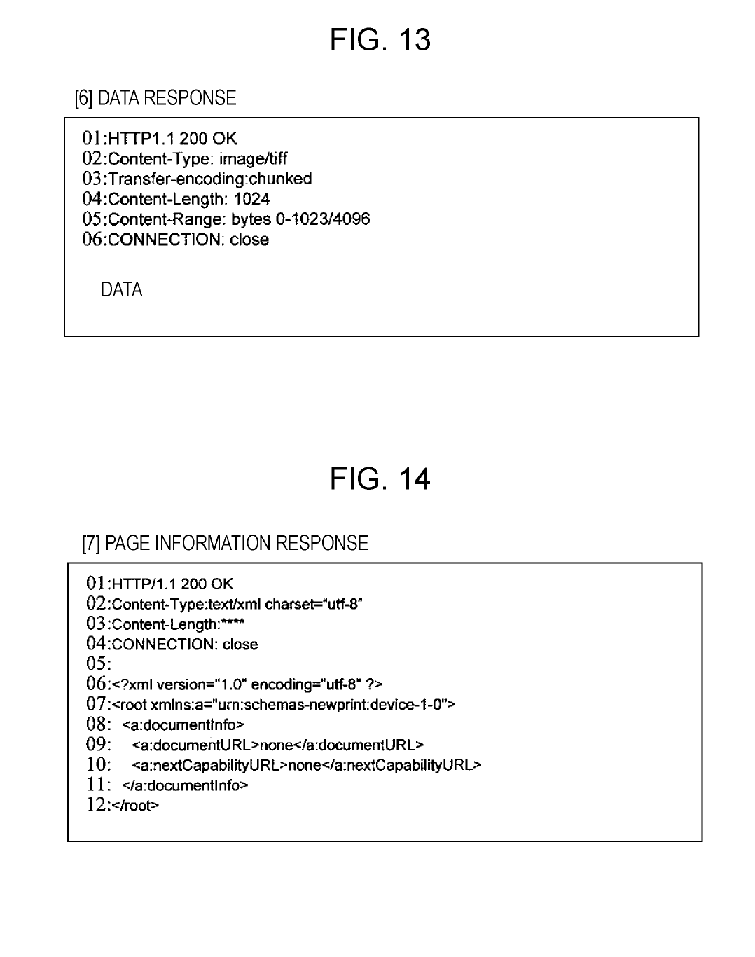

Next, the incoming correspondence terminal 30 issues a data request by transmitting a data request message to the outgoing correspondence terminal 20 using the obtained URL (the “newprint/scanprint.tiff” in line 09 of the page information response message shown in FIG. 11) (step S170 in FIG. 5 and step S350 in FIG. 6), and the outgoing correspondence terminal 20 issues a data response by transmitting a data response message and data to the incoming correspondence terminal 30 in response to the data request (step S360 in FIG. 6 and step S180 in FIG. 5). An example of the data request message is illustrated in FIG. 12. It can be seen that the “newprint/scanprint.tiff” written in line 01 of the data request message is the same as the “newprint/scanprint.tiff” in line 09 of the page information response message. It can also be seen in line 01 of the data request message shown in FIG. 12 that the data requested is a paper size “MediaSize” of A4 “iso_a4_{—}210×297 mm”, a quality “PrintQuality” of 200×200 dpi “200×200”, a file format “DocumentFormat” of tiff “img/tiff”, and a monochrome/color “MonoColor” setting of “color”. “Range” in line 03 specifies the data in the print content data that is to be transmitted/received, and in this working example, 1024 bytes, from 0-1023 bytes in a single page, is specified by the description “bytes=0-1023”. Any range may be set as long as it is within the range of a print memory capacity allocated to print data in the memory 36 of the incoming correspondence terminal 30. Note that when the print memory capacity allocated in the memory 36 of the incoming correspondence terminal 30 is sufficient, the “Range” in line 03 can be omitted, and in such a case, the entirety of the single page is specified as a result. An example of the data response message is illustrated in FIG. 13. It can be seen from “Content-Length: 1024” in line 04 that the data length is 1024 bytes and from “Content-Range: bytes 0-1023/4096” in line 05 that 0-1023 bytes of the total data amount of 4096 bytes are to be transmitted. The outgoing correspondence terminal 20 transmits the data response message to the incoming correspondence terminal 30, and also utilizes the scan execution unit 25 to read image data corresponding to the data described in the “Range” in line 03 of the data request message using the paper size, quality, file format, and monochrome/color settings specified as mentioned earlier, and transmits that data to the incoming correspondence terminal 30. Upon receiving the transmitted data, the incoming correspondence terminal 30 renders the received data using the print execution unit 34, and prints the data (step S190 in FIG. 5). The data requests and data responses are repeatedly executed until the page has been printed to the end (steps S170 to S200 in FIG. 5 and steps S350 to S370 in FIG. 6). Note that the end of the page is determined to be present when the data amount specified in the “Range” in line 03 of the data request message is not occupied, when that data does not exist, and so on.

When the page has been printed to the end, a page information request is issued from the incoming correspondence terminal 30 to the outgoing correspondence terminal 20 using the URL “newprint/capability2.xml” of the next page obtained from the page information response transmitted by the outgoing correspondence terminal 20 in response to the page information request that was issued to the outgoing correspondence terminal 20 (step S130 in FIG. 5 and step S320 in FIG. 6), a page information response is issued from the outgoing correspondence terminal 20 in response to the page information request (step S330 in FIG. 6 and step S140 in FIG. 5), and furthermore, data requests and data responses are repeatedly executed until that page has been printed to the end (steps S170 to S200 in FIG. 5 and steps S350 to S370 in FIG. 6).

When neither the URL of the print content data nor the URL of the next page has been obtained from the outgoing correspondence terminal 20, the incoming correspondence terminal 30 determines that the transmission of the print content data has ended (step S150 in FIG. 5), and transmits “BYE” (see FIG. 2) to the outgoing correspondence terminal 20 in order to terminate the session. FIG. 14 illustrates an example of a page information response message transmitted from the outgoing correspondence terminal 20 in response to a page information request from the incoming correspondence terminal 30 when the transmission of the print content data has ended. It can be seen from “none” in line 09 and “none” in line 10 of the page information response message that neither the URL of the print content data nor the URL of the next page are present. Having received the “BYE” (step S340 in FIG. 6), the outgoing correspondence terminal 20 transmits “200 OK” to the incoming correspondence terminal 30 in order to terminate the session. The transmission of the “BYE” and “200 OK” has already been described.

According to the printing system and incoming correspondence terminal 30 of the working example described thus far, when “newprint1” is written in the line “m=” as the content of the INVITE message SDP when initiating a session in order to identify that the transmission/reception of the print content data is included, the transmission/reception of the print content data in response to a request from the incoming correspondence terminal 30 and the printing of the print content data by the incoming correspondence terminal 30 are executed with the outgoing correspondence terminal 20 functioning as the server in the server/client model and the incoming correspondence terminal 30 functioning as the client in the server/client model. This makes it possible to transmit/receive and print the print content data in accordance with the capabilities of the incoming correspondence terminal 30. As a result, the print content data can be properly received and printed via an IP network. Furthermore, because data is transmitted/received and printed having specified an amount of the print content data to be transmitted/received that is within the range of the print memory capacity allocated for print data out of the capacity in the memory 36 of the incoming correspondence terminal 30, the print content data can be properly transmitted/received and printed even when only a small print memory capacity has been allocated for print data from the capacity in the memory 36 of the incoming correspondence terminal 30.

In this working example, the outgoing correspondence terminal 20 corresponds to a “transmitting terminal”, the incoming correspondence terminal 30 corresponds to a “printer terminal”, and the IP network 10 corresponds to an “IP network” in the printing system according to the invention. In the outgoing correspondence terminal 20 and the “transmitting terminal”, the SIP UA 23 that initiates a session by transmitting, to the incoming correspondence terminal 30, an INVITE message in which “newprint 1” is written in the line “m=” as the content of the INVITE message SDP in order to identify that the transmission/reception of print content data is included corresponds to a “transmission-side connection initiation execution unit”, and the control unit 22 that executes the processing on the outgoing correspondence side shown in FIG. 6 for reading image data using the scan execution unit 25 and transmitting that data to the incoming correspondence terminal 30 in response to a request from the incoming correspondence terminal 30 based on the “newprint1” description while the outgoing correspondence terminal 20/“transmitting terminal” functions as the server in the server/client model corresponds to a “print content transmitting unit”. In the incoming correspondence terminal 30 and the “printer terminal”, the memory 36 corresponds to a “storage unit”; the print execution unit 34 corresponds to a “print execution unit”; the SIP UA 33 that initiates a session by receiving an INVITE message transmitted from the outgoing correspondence terminal 20 in which “newprint1” is written in the line “m=” in order to identify that the transmission/reception of print content data is included corresponds to a “reception-side connection initiation execution unit”; and the control unit 32 that executes the processing on the incoming side shown in FIG. 5 for receiving and printing the data transmitted from the outgoing correspondence terminal 20 in response to a request for print content data based on the “newprint1” description while the incoming correspondence terminal 30/“printer terminal” functions as the client in the client/server model corresponds to a “print content reception/printing control unit”. Furthermore, in a printer terminal according to the invention, the memory 36 corresponds to a “storage unit”; the print execution unit 34 corresponds to a “print execution unit”; the SIP UA 33 that initiates a session by receiving an INVITE message transmitted from the outgoing correspondence terminal 20 in which “newprint1” is written in the line “m=” in order to identify that the transmission/reception of print content data is included corresponds to a “reception-side connection initiation execution unit”; and the control unit 32 that executes the processing on the incoming side shown in FIG. 5 for receiving and printing the data transmitted from the outgoing correspondence terminal 20 in response to a request for print content data based on the “newprint1” description while the incoming correspondence terminal 30/““printer terminal” functions as the client in the client/server model corresponds to a “print content reception/printing control unit”.

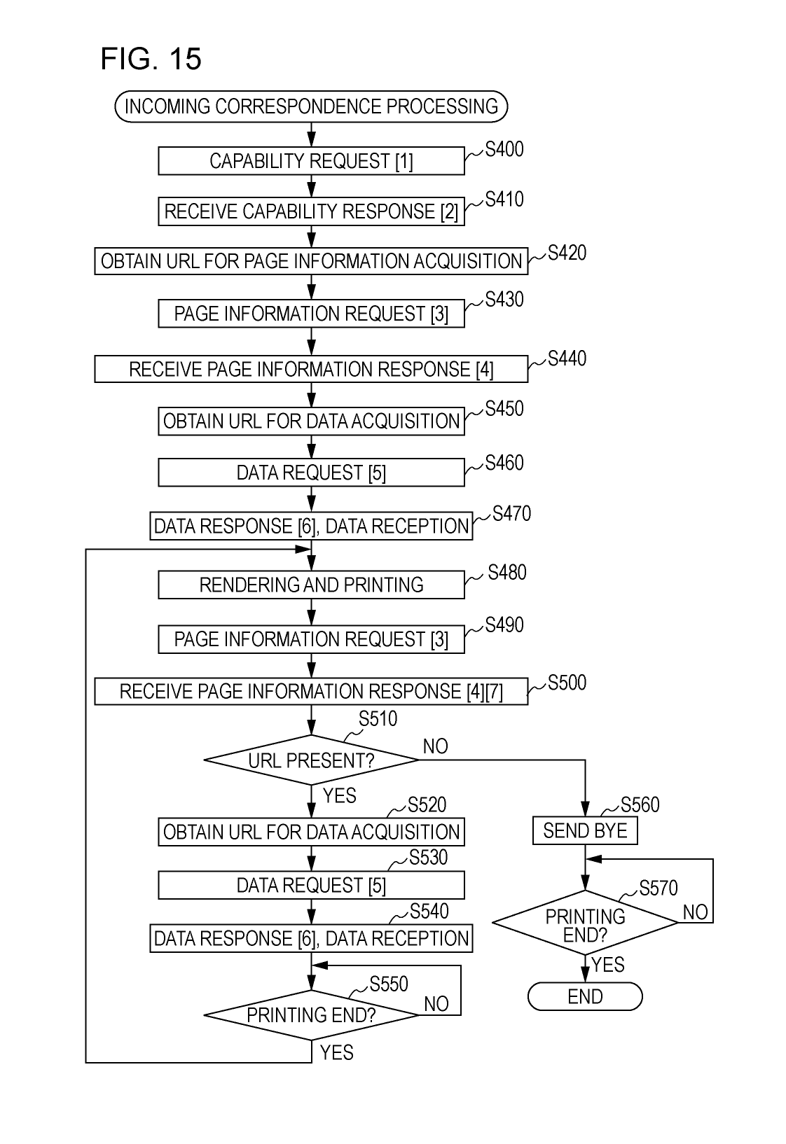

Although the printing system and incoming correspondence terminal 30 are described in the working example as transmitting/receiving print content data in 1024-byte units, which is set as the range of the print memory capacity allocated for print data in the memory 36 of the incoming correspondence terminal 30, two pages' worth of a print memory region may be prepared in the memory 36 of the incoming correspondence terminal 30, and one pages' worth of data may be received in one print memory region while the one pages' worth of data in the other print memory region is in the middle of being printed. An example of the processing on the incoming side in such a case is illustrated in FIG. 15. Steps S400 to S440 in the processing on the incoming side in FIG. 15 are the same as steps S100 to S140 in the processing on the incoming side in FIG. 5, and steps S450 to S480 in the processing on the incoming side in FIG. 15 are the same as steps S160 to S190 in the processing on the incoming side in FIG. 5 aside from the data requests and data responses being issued on a page-by-page basis. When a page's worth of data has been stored in one print memory region in the memory 36 through the processing from steps S400 to S470, the rendering and printing is commenced on the page's worth of data stored in the one print memory region (step S480); meanwhile, a page information request is carried out by transmitting a page information request message to the outgoing correspondence terminal 20 in the same manner as in step S430, and a page information response message transmitted from the outgoing correspondence terminal 20 in response to the page information request is then received (step S500). Upon receiving the page information response message from the outgoing correspondence terminal 20, if the URL of the print content data, the URL of the next page of the print content, or the like is present in the page information response message, the incoming correspondence terminal 30 obtains those URLs (steps S510 and S520), carries out a data request by transmitting a data request message using the obtained URLs (step S530), receives a data response message and a page's worth of data transmitted from the outgoing correspondence terminal 20 in response to the data request, and stores the page's worth of data in the other print memory region of the memory 36 (step S540). Then, the incoming correspondence terminal 30 waits for the printing of the data stored in the one print memory region of the memory 36 to end (step S550), commences the rendering and printing of the page's worth of data stored in the other print memory region of the memory 36 (step S480), and executes the processing for storing the next page's worth of data in the one print memory region of the memory 36 for which the printing has ended, or in other words, executes the processing of steps S490 to S540. When neither the URL of the print content data nor the URL of the next page is present in the page information response message from the outgoing correspondence terminal 20, it is determined that the transmission of print content data has ended (step S510); the incoming correspondence terminal 30 transmits “BYE” (see FIG. 2) to the outgoing correspondence terminal 20 in order to terminate the session (step S560), waits for the current printing to end (step S570), and ends the processing on the incoming side. Note that the processing on the outgoing side corresponding to the processing on the incoming side is processing responding to the sequence numbers in the processing on the incoming side, and thus has the same sequence number responses as in FIG. 6. In this manner, data is printed from one of the print memory regions while data is received by the other print memory region, which makes it possible to reduce the amount of time spent transmitting/receiving print content data.

With the printing system according to the working example, the outgoing correspondence terminal 20 is described as functioning as the server in the server/client model and the incoming correspondence terminal 30 is described as functioning as the client in the server/client model when “newprint1” is written in the line “m=” as the content of the INVITE message SDP when initiating a session in order to identify that the transmission/reception of print content data is included. However, an identifier may be written in the INVITE message in order to identify that the transmission/reception of print content data is included, and thus the identification is not limited to the “newprint1”; any description may be used as long as it enables identification.

With the printing system according to the working example, data is transmitted/received having specified 1024 bytes, from 0-1023 bytes of a single page, using the description “bytes=0-1023” in the data request message; however, it is acceptable to specify only the data amount. In this case, the data amount is of course not limited to 1024 bytes.

With the incoming correspondence terminal 30 according to the working example, both the scan execution unit 35 and the memory card driver 37 are provided; however, one of the scan execution unit 35 and memory card driver 37 may be omitted, or both the scan execution unit 35 and the memory card driver 37 may be omitted.

In the working example, the outgoing correspondence terminal 20 is described as being provided with the print execution unit 24, scan execution unit 25, the memory card driver 27, and so on; however, it is acceptable to provide only some of the print execution unit 24, the scan execution unit 25, and the memory card driver 27, or to provide none at all, as long as the print content data to be transmitted is stored. In other words, the outgoing correspondence terminal 20 may take on any configuration as long as it is capable of transmitting print content data.

Although an embodiment of the invention has been described using a working example, the invention is not intended to be limited to the aforementioned working example in any way, and it goes without saying that various other embodiments can be employed without departing from the essential spirit of the invention.

The invention is useful in manufacturing industries for printing systems, printer terminals, and so on.

What is claimed is:

1. A printing system comprising a transmitting terminal that transmits printable print content and a printer terminal that receives and prints the print content, the terminals being connected via an IP network,
wherein the transmitting terminal includes:
a transmission-side connection initiation execution unit that initiates a connection with the printer terminal via the IP network based on the transmission of a connection request message that contains print identification information for transmitting/receiving the print content; and
a print content transmitting unit that transmits the print content to the printer terminal in response to a request from the printer terminal, the print content transmitting unit functioning as the server in the server/client model when the connection with the printer terminal is initiated based on the transmission of the connection request message that contains the print identification information, and
the printer terminal includes:
a storage unit capable of temporarily storing data;
a print execution unit that prints print data;
a reception-side connection initiation execution unit that initiates a connection along with the transmitting terminal via the IP network based on the reception of the connection request message that contains the print identification information; and
a print content reception/printing control unit that receives the print content from the transmitting terminal having issued, to the transmitting terminal, a request to transmit the print content, and controls the print execution unit so that the received print content is printed, the print content reception/printing control unit functioning as the client in the client/server model when the connection with the transmitting terminal is initiated based on the reception of the connection request message containing the print identification information.

2. The printing system according to claim 1,
wherein the print content reception/printing control unit of the printer terminal receives data multiple times by transmitting, to the transmitting terminal, multiple data transmission requests for a data amount that is within the range of a print memory capacity allocated to print data from the storage capacity of the storage unit, and controls the print execution unit so that the received data is printed by the print execution unit with each data reception; and
the print content transmitting unit of the transmitting terminal transmits the print content by transmitting data multiple times in response to the data transmission requests from the printer terminal.

3. The printing system according to claim 2,
wherein the print content reception/printing control unit of the printer terminal performs control so that data transmission requests are made for each of predetermined printing ranges and the data received from the predetermined printing ranges is printed on a range-by-range basis;
the transmitting terminal further includes a scan execution unit that reads an image;
the print content transmitting unit of the transmitting terminal controls the scan execution unit to read a portion of the image corresponding to the predetermined printing rage in response to a data transmission request from the printer terminal, and transmits the read data to the printer terminal.

4. The printing system according to claim 3,
wherein the storage unit of the printer terminal is provided with two print memory regions, each having a storage capacity equivalent to one page;
the predetermined printing range is one page; and
the print content reception/printing control unit of the printer terminal makes a data transmission request so that data is written into one of the print memory regions when the data stored in the other print memory region is being printed.

5. A printer terminal, connected via an IP network to a transmitting terminal that transmits printable print content, that prints the print content transmitted from the transmitting terminal, the printer terminal comprising:
a storage unit capable of temporarily storing data;
a print execution unit that prints print data;
a reception-side connection initiation execution unit that initiates a connection along with the transmitting terminal via the IP network based on the reception of a connection request message that contains print identification information for transmitting/receiving the print content transmitted from the transmitting terminal; and
a print content reception/printing control unit that receives the print content from the transmitting terminal having issued, to the transmitting terminal, a request to transmit the print content, and controls the print execution unit so that the received print content is printed, the print content reception/printing control unit functioning as the client in the client/server model when the connection with the transmitting terminal is initiated based on the reception of the connection request message containing the print identification information.

6. The printer terminal according to claim 5,
wherein the print content reception/printing control unit receives data multiple times by transmitting, to the transmitting terminal, multiple data transmission requests for a data amount that is within the range of a print memory capacity allocated to print data from the storage capacity of the storage unit, and controls the print execution unit so that the received data is printed by the print execution unit with each data reception.

7. The printer terminal according to claim 6,
wherein the print content reception/printing control unit performs control so that data transmission requests are made for each of predetermined printing ranges and the data received from the predetermined printing ranges is printed on a range-by-range basis.

8. The printer terminal according to claim 7,
wherein the storage unit is provided with two print memory regions, each having a storage capacity equivalent to one page;
the predetermined printing range is one page; and
the print content reception/printing control unit makes a data transmission request so that data is written into one of the print memory regions when the data stored in the other print memory region is being printed.
